(19) United States
(12) Patent Application Publication
(10) Pub. No.: US 2008/0104814 A1
(43) Pub. Date: May 8, 2008

(54) Semiautomatic installation tool

(76) Inventors: Stanley Buchanan, Morgan, UT (US); Lynn Noyes, Layton, UT (US); James Ferrero, Farr West, UT (US)

Correspondence Address: RAGGIO & DINNIN, P.C., 2701 CAMBRIDGE COURT, STE. 410, AUBURN HILLS, MI, 48326, US

(21) Appl. No.: 11/593,763

(22) Filed: Nov. 7, 2006

(51) Int. Cl. B23P 19/04; B23P 19/06

(52) U.S. Cl. 29/240.5

(57) ABSTRACT

A slimcert installation tool for installation of inserts into a work piece. The tool comprises a driver body having a hex shank and a sleeve arranged around the driver body. The tool also comprises a spring arranged between the sleeve and the driver body. A collar is arranged over an end of the sleeve.

### BACKGROUND OF THE INVENTION

1. Field of the Invention

The subject invention generally relates to an installation tool, and more particularly, relates to a semiautomatic slimcert installation tool.

2. Description of Related Art

It is well known in the prior art to use threaded inserts as housings or mounts for various equipment. Threaded inserts are used when the material from which the housing or mount is formed is incapable of withstanding the forces that would be brought upon such material when a fastener is placed in a tapped hole in the housing or mount. Generally, a prior art insert is placed into a tapped hole in the housing or mount and swaged so that a portion of the insert engages the parent material. This will usually prevent the insert from rotating or backing out of the material due to vibration or other external forces. Many of these prior art inserts or secondary fasteners are made of steel and are placed in a work piece which generally is made of a relatively soft material compared to that of the insert. The installation of the insert in the work piece will allow for receipt of a primary fastener to be securely held within the work piece under loads that would ordinarily cause the threads of the fastener to be stripped or pulled out of the softer material of the work piece.

These prior art inserts come in several known shapes and sizes depending on the nature of the work in which the insert will be used. Many varieties of installation procedures have been developed for installing inserts into work pieces in the prior art. One such older methodology involves using a hex wrench that is precisely fitted into the end of an insert and then turning the wrench to install the insert to a predetermined depth. Another known prior art method involves a two step operation in which a drive wrench having a hexagonally shaped key at its outer end engages a matching hexagonal wrenching surface on the threaded inner surface of the insert. The wrench has a handle that is rotated manually until the insert is threadably installed in the work piece hole to the correct depth. After the drive wrench is removed from the insert a swaging tool is applied to the insert to manually swage barbs radially outward into the counter bore of the work piece hole. However, in this and other prior art methodologies it may take several attempts to accurately install the insert to the correct depth, thus increasing the time to install the insert and manufacturing costs for the manufacturer.

Other methodologies may also be used to install prior art inserts. However, it should be noted the difficulties arise with many of these prior art inserts including no insurance that the inserts are completely threaded through their entire inner bore. Hence, in the prior art one problem may arise when some inserts were installed that were not threaded, thus creating an insert that was not useful in operation. Furthermore, other problems occurred with the prior art inserts and methodologies for installing them when the hex wrench had to be constantly removed to measure depth and then replaced to make adjustments to the depth thus increasing the amount of time required to properly install the insert and increasing the chance for misthreading and damage to the interior threads of the insert by the removal of the hex wrench numerous times.

Therefore, there is a need in the art for an improved insert installation tool. Furthermore, there is a need in the art for a semiautomatic slimcert installation tool that will ensure that the insert is completely threaded through its entire inner bore. Also there is a need in the art for a slimcert automatic installation tool that will release the insert to its proper depth and prevent back out of the insert when removing the slimcert installation tool therefrom.

### SUMMARY OF THE INVENTION

One object of the present invention may be to provide an improved semiautomatic slimcert installation tool.

Another object of the present invention may be to provide a slimcert installation tool that ensures that the insert is completely threaded throughout the entire length of its inner bore.

Still another object of the present invention may be to provide an installation tool that will release the insert at proper depth.

Still another object of the present invention may be to provide an installation tool that prevents back out of the insert during removal of the installation tool therefrom.

Another object of the present invention may be to provide an installation tool that has a hex shank and a threaded installation end.

Still another object of the present invention may be to provide an installation tool that includes a back away collar that will prevent backing out of the insert when removing the tool therefrom.

Still another object of the present invention may be to provide a Teflon bearing faced breakaway depth setting collar that will drive the insert to a predetermined depth and automatically release as the installation tool is removed.

To achieve the foregoing objects, a slimcert installation tool is disclosed. The tool includes a driver body having a hex shank and a sleeve arranged around the driver body. The tool also comprises a spring arranged between the sleeve and the driver body and a break away or removable collar arranged over an end of the sleeve.

One advantage of the present invention may be that it provides a novel and improved slimcert installation tool.

Still a further advantage of the present invention may be that it provides an installation tool that ensures the insert is completely threaded with its entire inner bore.

Still another advantage of the present invention may be that it provides an installation tool that will release the insert at a predetermined proper depth.

Yet a further advantage of the present invention may be that it prevents back out of the insert when removing the installation tool therefrom.

Still another advantage of the present invention may be that it provides an installation tool that has a hex shank on one end thereof and a threaded installation end on the opposite end thereof.

Yet a further advantage of the present invention may be that it provides a Teflon bearing faced breakaway depth setting collar on one end that will drive the insert to a predetermined depth and automatically release the installation tool after insertion of the insert.

Other objects, features and advantages of the present invention will become apparent from the subsequent description and appended claims, taken in conjunction with the accompanying drawings.

### BRIEF DESCRIPTION OF THE DRAWINGS

FIG. 1 shows a perspective view of a slimcert installation tool according to the present invention.

FIG. 2 shows an exploded view of a slimcert installation tool according to the present invention.

FIG. 3 shows a side view of a driver body according to the present invention.

FIG. 4 shows a top view of the driver body according to the present invention.

FIG. 5 shows a top view of the set collar according to the present invention.

FIG. 6 shows a cross section view of the collar taken along line 6-6 of FIG. 5.

FIG. 7 shows a top view of the sleeve according to the present invention.

FIG. 8 shows a side view of the sleeve according to the present invention.

### DESCRIPTION OF THE EMBODIMENT(S)

Referring to the drawings, a slimcert installation tool 10 for use in properly driving inserts into a predetermined material is disclosed. The slimcert installation tool 10 will be for use in inserting inserts into any known material which generally is a softer material such as aluminum, composite or the like versus that of the insert 12 which generally is a steel or other hard metal material. However, it should be noted that the insert 12 can be made of any known material while such inserts 12 may be inserted into any known material depending on the design requirements and use for such inserts 12 and the material or components being held therein. The semiautomatic slimcert installation tool of the present invention will ensure that the insert 12 is threaded throughout the entire inner bore 14 thereof and also will ensure that the insert 12 is released at a predetermined and proper depth within the work piece into which the insert 12 is being secured. Furthermore, the slimcert semiautomatic installation tool 10 will prevent back out of the insert 12 when removing the installation tool from the insert 12 being placed within the work piece. Generally, the work piece into which the insert 12 is placed is made of a softer material then the insert 12, such that a fastener being secured therein will hold and create a more secure connection with the piece or component being held by the fastener to or on the work piece. If the fastener were directly placed into the work piece, which generally is made of a softer material, such as aluminum, composite, plastic, etc., such fastener may loosen or pull out of the softer material when forces are applied to the work piece in the operational environment of the work piece.

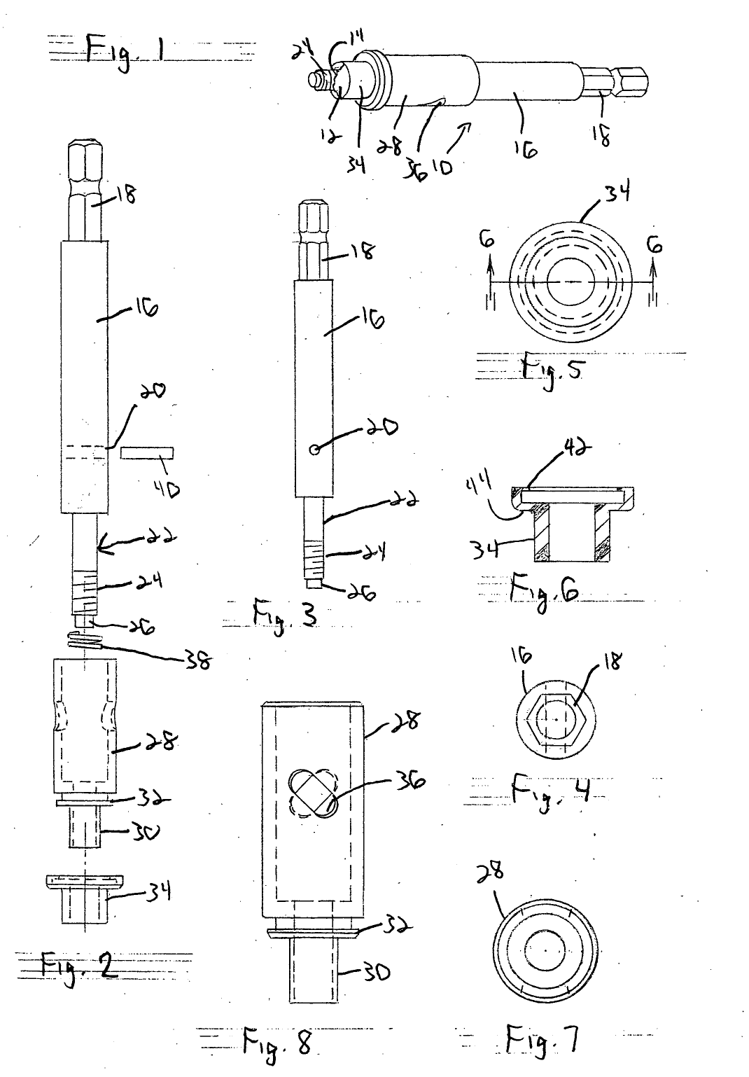

FIGS. 1 through 8 show a semiautomatic slimcert installation tool 10 according to the present invention. It should be noted that the installation tool 10 of the present invention generally is used for a threaded insert 12, but may be modified to be used for inserts that are not threaded. The threaded installation tool 10 includes a driver body 16, which is generally made of a steel material. However, it should be noted that any other metal, ceramic, composite, plastic or natural material may be used for the driver body 16 depending on the design requirements and environment the installation tool 10 will be used in. The driver body 16 includes a hex shank 18 extending from one end thereof. The hex shank 18 generally will be designed to fit with and be used by any standard powered screw driver or drill. It should be noted that any other shaped shank may be used depending on the design requirements for the installation tool 10. The hex shank 18 will have a predetermined length and a predetermined diameter. In one embodiment the diameter of the hex shank 18 is approximately 0.25 inches. However, any other diameter shank may be used depending on the drill or electric screw driver used to properly set the insert 12 within the work piece. The length of the shank may be any known length depending on the design requirements of the driver body 16, however in one embodiment contemplated the shank 18 will have a length of 0.8 inches. The driver body 16 also includes an orifice 20 through a diameter thereof. The orifice 20 will have a predetermined size and generally will have a circular shape, however any other known shape can be used for the orifice 20. The orifice 20 will intersect with a center line of the body 16. An extension 22 extends from the driver body 16 on the end opposite of the hex shank 18. The extension 22 is generally circular in cross section or cylindrical like and generally will have a predetermined length that in one embodiment contemplated is 0.90 inches, however any length may be used for the extension 22. The extension 22 generally has a reduced diameter compared to that of the other portions of the driver body 16. The extension 22 generally will have a predetermined threaded 24 portion. The threads will allow for the installation tool 10 to verify the presence of threads on the inner bore 14 of the insert 12 being installed by the tool 10. The end portion 26 of the extension 22 has a further reduced diameter compound to the other portions of the extension 22. In one contemplated embodiment the end portion 26 has a diameter of 0.152 inches while the other portion of the extension 22 has a diameter of 0.190 inches, however any other known diameters may also be used. The threaded portion 24 extends a predetermined distance on the extension 22 from the end thereof. It should be noted that the driver body 18 generally is made of a steel material, however any other known metal, ceramic, composite, plastic or the like may be used to make the driver body 16.

The installation tool 10 also includes a sleeve 28 which is arranged over an end of the driver body 16 opposite the hex shank 18. The sleeve 28 generally is made of a steel material, however any other metal, composite, ceramic, plastic, or natural material may also be used for the sleeve 28. The sleeve 28 has an inner bore or cavity with a predetermined inner diameter and the sleeve 28 has an outer diameter such that the inner diameter will slide over the outer diameter of a portion of the driver body 16. The inner diameter of one contemplated embodiment of the sleeve 28 is approximately 0.377 inches while the outer diameter of one portion of the driver body 16 is approximately 0.375 inches, thus allowing for the sleeve 28 to be slid over the outer diameter of one portion of the driver body 18. The outer diameter of the sleeve 28 is approximately one half inch, however any other size sleeve 28 and driver body 18 may be used depending on the dimensions needed for the tool 10 or insert 12. A generally circular or tubular extension 30 extends from one end of the sleeve 28. The tubular extension 30 generally has an inner diameter that approximately the same size or a little larger than the outer diameter of the circular extension 22 of the driver body 16. Therefore, the circular extension 22 will be slidably arranged within the tubular extension 30 of the sleeve 28. Arranged at or near the intersection of the sleeve 28 and the tubular extension 30 is a circular lip 32. This circular or circumferential lip 32 will allow for connection and holding of a break away or removable set collar 34 to the sleeve 28 of the slimcert installation tool 10. The circumferential lip 32 generally has a diameter that is less than the width of the outer surface of the sleeve 28. Such diameter of the lip 32 is usually greater than the diameter of the tubular extension 30. However, it should be noted that the shape and size of the circumferential lip 32 may be different depending on the overall design requirements and dimensions of the sleeve 28 with comparison to the driver body 16. The sleeve 28 also may include at least one slot 36 through a surface thereof. In one contemplated embodiment a first and second slot 36 will be arranged across from one another on opposite surfaces of the sleeve 28. In the embodiment shown, the slot 36 generally have an oval shape, however any other shape slot may be used for the sleeve 28 of the installation tool 10. It should be noted that in one embodiment the slot 36 is machined or milled therein, however it is also contemplated to have the slot 36 cast or molded therein.

The sleeve 28 is slid or arranged over the end of the driver body 16 such that a spring 38 is arranged between a surface of the driver body 16 and a surface of the sleeve 28. The spring 38 generally is made of a steel material, however any other metal, composite, plastic, ceramic, or natural material may be used for the spring 38. The spring 38 is arranged over the circular extension 22 of the driver body 16 until it contacts a portion of the driver body 16 having the largest diameter. The spring 38 also contacts on the opposite end an inner surface of the sleeve 28. The spring 38 will urge the driver body 16 in a linear direction away from the sleeve 28. Thus, the sleeve 28 and driver body 16 will be urged away from one another in a linear direction via the spring 38 arranged therebetween. A dowel pin 40 generally made of a steel material, however it should be noted that any other metal, ceramic, composite or natural material may be used for the dowel pin 40 is arranged within the orifice 20 of the driver body 16. The length of the dowel pin 40 is such that it extends beyond the surface of the driver body 16 on both sides thereof. The portion of the dowel pin 40 that extends beyond the side surfaces of the driver body 16 are then arranged within the slots 36 arranged through the surfaces of the sleeve 28. This will ensure that the driver body 16 and sleeve 28 are securely connected to one another and cannot be dislodged from one another via the force of the spring 38 arranged between the driver body 16 and sleeve 28. This also will allow for a predetermined amount of linear movement between the driver body 16 and sleeve 28 to ensure proper insertion of the insert 12 into the work piece.

The slimcert installation tool 10 also includes a break away or removable set collar 34 arranged over the end of the sleeve 28. The set collar 34 generally has a cylindrical shape with a circumferential flange 42 extending therefrom. The circumferential flange 42 will engage with the circumferential lip 32 of the sleeve 28 to hold or removably secure the set collar 34 to the sleeve 28 during operation of the slimcert installation tool 10. In one contemplated embodiment the set collar 34 is made of a nylon material, however any other known plastic, composite, metal, ceramic, or natural material may be used for the set collar 34. It should also be noted that the set collar 34 is contemplated to have a Teflon coating applied to the surfaces thereof to create a bearing faced break away mechanism that will automatically release as the installation tool 10 is removed from the insert 10 and work piece. The coating of the set collar 34 with tetraflourethylene or Teflon will ensure for easy removal of the tool and ensure back away does not occur with the insert 12. It should be noted that the break away collar 34 may be completely made of a Teflon material. Furthermore, Teflon may just be applied at predetermined portions of the set collar 34 to ensure a smooth breakaway from the sleeve 28 when the tool 10 is removed from the insert 12. The outer diameter of the breakaway set collar 34 will generally mimic that of the orifice in which the insert 12 is being placed such that the set collar 34 remains in the hole after removal of the tool 10 from the insert 12. It is contemplated to use the set collar 34 as a reusable piece, however it may just be a one time use piece wherein a new set collar 34 may be used for each insert 12 placed within an orifice. Generally, the set collar 34 has a similar or same diameter as that of the insert 12, however other sized collars 34 or inserts 12 may also be used. After the insert 12 is threaded onto the extension 22 of the tool 10 one end of the insert 12 will engage or contact an end of the set collar 34.

In operation an insert 12 will be arranged and placed within an orifice of a generally soft material work piece. The insert 12 will first be threaded, via its internal threaded bore onto the threaded portion 24 of the driver body 16. This will ensure that the insert 12 being placed in the work piece, has threads arranged along the entire inner bore of the insert 12. After the insert 12 is threaded onto the threaded portion of the driver body 16 the insert 12 will be in contact with the set collar 34 on one end. Next the tool 10 will be arranged in an orifice within the work piece into which the insert 12 is being placed. The driver body 16 will then be turned until the insert 12 is placed and secured within the work piece to a predetermined depth as measured by the set collar 34 which is secured to the outer surface of the sleeve 28 via the circumferential lip 32 and circumferential flange 42 of the set collar 34. It should be noted that the tool 10 will be turned either manually with a hex wrench or via any known electric screw driver or drill. The insert 12 will be properly placed at the predetermined depth within the work piece when a shoulder surface 44 of the set collar 34 engages with the outer surface of the work piece. Hence, when the engagement occurs between the set collar 34 and the outer surface of the work piece, the operator of the slimcert installation tool 10 will stop the rotational force from being applied thereto. Then the operator of the slimcert installation tool 10 will reverse the rotation to remove the installation tool 10 from the threaded portion of the insert 12. Upon removal of the tool 10 the set collar 34 will break away from the circumferential lip 32 of the sleeve 28 and remain in the orifice into which the insert 12 was placed. This will ensure for proper installation of the insert 12 to the required depth and easy removal of the slimcert installation tool 10. Furthermore, the set collar 34 will ensure that the insert 12 will not back away, be partially removed or backed out when the tool 10 is removed from the insert 12 from the proper position within the work piece. After the tool is removed the set collar 34 can either be left in the work piece, removed and reused or thrown away depending on the design requirements and environment in which the slimcert installation tool 10 will be used. The operator of the slimcert installation tool 10 can then reuse the installation tool 10 to place other inserts throughout the work piece where needed.

Therefore, the semiautomatic slimcert installation tool 10 of the present invention includes a threaded installation end 24 to ensure that the inserts 12 are completely threaded throughout their entire internal bore. Furthermore, they include a Teflon bearing faced break away depth setting collar 34 that will drive the insert 12 to a predetermined depth and automatically release as the installation tool 10 is removed from the insert 12.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A slimcert installation tool, said tool comprising:
a driver body having a hex shank;
a sleeve arranged around said driver body;
a spring arranged between said sleeve and said driver body; and
a break away collar arranged over an end of said sleeve.

2. The tool of claim 1 wherein said driver body having an orifice through a diameter thereof.

3. The tool of claim 1 wherein said driver body having a threaded portion on an end opposite of said hex shank.

4. The tool of claim 3 wherein said threaded portion having a reduced diameter.

5. The tool of claim 2 wherein said driver body further including a pin arranged within said orifice.

6. The tool of claim 5 wherein said sleeve having a slot through a surface thereof.

7. The tool of claim 6 wherein said pin is arranged within said slot.

8. The tool of claim 1 wherein said sleeve having a circumferential lip.

9. The tool of claim 8 wherein said collar having a circular flange.

10. The tool of claim 9 wherein said circular flange engages with said lip to removably hold said collar to said sleeve.

11. The tool of claim 1 wherein said collar having a tetraflourethylene material and said collar breaks away from said sleeve when predetermined conditions exist.

12. The tool of claim 1 wherein said spring urges said sleeve away from said driver body.

13. A semiautomatic slimcert installation tool, said tool comprising:
a driver body having an orifice through a diameter thereof;
a sleeve having a slot therein, said sleeve arranged over an end of said driver body;
a pin arranged through said orifice and within said slot;
a spring arranged between said driver body and said sleeve; and
a removable collar connected to one end of said sleeve.

14. The tool of claim 13 wherein said collar having a tetraflourethylene coating thereon.

15. The tool of claim 13 wherein said sleeve having a circular lip extending from a surface thereof.

16. The tool of claim 15 wherein said collar having an inward extending circumferential flange on one end, said flange engages with said lip to hold said collar to said sleeve until predetermined conditions are met wherein said collar will break away from said sleeve.

17. The tool of claim 13 wherein said driver body having a hex shank on one end.

18. The tool of claim 13 wherein said driver body having a reduced diameter extension on one end, said reduced diameter extension is partially threaded.

19. The tool of claim 13 further comprising a second slot through said sleeve, said pin having a length that is greater than said diameter of said driver body wherein said pin extends into said slots.

20. The tool of claim 18 wherein said threaded portion insures an insert is completely threaded and said collar will prevent back out of said insert when the tool is removed from said insert.

21. A method of inserting an insert into a work piece using a semiautomatic installation tool, the method including the steps of:
engaging a break away set collar with a sleeve of the tool;
threading the insert onto an end of the tool into contact with said collar;
driving said insert into an orifice of the work piece until said collar engages a surface of the work piece; and
removing the tool from the insert wherein said collar will break away from the tool ensuring proper depth placement of the insert and preventing the insert from backing out.
